(19) United States
(12) Patent Application Publication
(10) Pub. No.: US 2004/0107636 A1
(43) Pub. Date: Jun. 10, 2004

(54) Seed purification using ultra violet generated ozone

(76) Inventors: Lawrence Gene Costello, Orange, CA (US); Elizabeth S. Jenkins Lincoln, Groveland, FL (US)

Correspondence Address: LAWRENCE GENE COSTELLO, 720 N. ADELE #4, ORANGE, CA, 92867, US

(21) Appl. No.: 09/819,404

(22) Filed: Mar. 29, 2001

Related U.S. Application Data
(60) Provisional application No. 60/195,482, filed on Apr. 10, 2000.

(51) Int. Cl. A01C 1/00

(52) U.S. Cl. 47/58.1 SE

(57) ABSTRACT

A Process for acheiving a 5 log reduction (99%) of bacteria on seeds using ultraviolet activated oxygen gas. The seeds are in a tank and the gas is introuced using a sparging system that allows the gas to be delivered in 20 to 60 micron bubbles for greater contact area between the seed and and gas, allowing the activated oxygen to reduce bacteria fast and efficiently. Also, the water is saturated with ultraviolet activated oxygen for use in germination and aiding in the growing processes. This reduction of bacteria results in extended shelf life (and no chlorine is used).

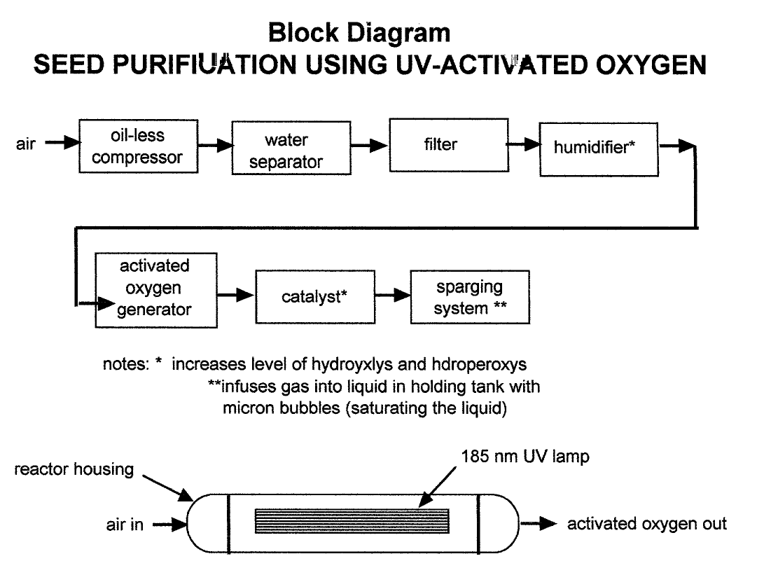

### DESCRIPTION

1. Field of Invention

Activated oxygen has been used since 1982 for bacteria reduction in hydroponic operations.

Activated oxygen has been used since 1982 to reduce pesticides, biocides, rodentcides, VOC'S etc. on fruit (apples oranges, pears, etc.).

Activated oxygen has been used since 1996 at an alfalfa seed facility for bacteria reduction.

In 1996 specific testing was done at an alfalfa sprout facility in Hawaii using the activated oxygen to reduce bacteria and aid in control of bacteria during germanation and growth period.

In 1996 specific testing was done at a hydroponic facility in Hawaii to reduce bacteria and algae growth and decrease water surface tension (to enhance oxidation of micro nutrients and for better assimilation by the root system).

2. Description of Related Art

Activated oxygen has been used since 1982 to reduce bacteria on the exterior of vegetables (ie. tomato, pepper, celery, etc) and to extend shelf life.

Activated oxygen has been used since 1988 to reduce bacteria in fruit juices. (orange, cranberry, prune, etc) in Michigan.

### SUMMARY

Based on technical information obtained from activities stated in “field of invention” and “description of related art” and on testing since 1985 a specific protocol has been formulated to efficiently and at a low cost reduce the bacteria from vegetable seeds using activated oxygen and at the same time extend shelf live.

At present the only FDA approved method to obtain a 5 log reduction is to soak the seed in a 20,000 PPM chlorine solution. (this very high chlorine concentration has many drawbacks):

A. Inhaling is hazardous to personnel

B. Storing/handling can be hazardous to personnel and cause extra expenses (insurance, special clothing etc.)

C. After the soaking process, with a chlorine solution the seeds require a minimum 3 rinses to 5 rinses to remove the chlorine residue. This is an added expense, and if the rinse water is contaminated you have introduced another problem (the extra cost involved in removing the chlorine from the water before discharging into the sewer)

D. The extra cost of chlorine.

During hydroponic operations when water is saturated with activated oxygen the surface tension is lowered (this makes it easier for the roots to access the micro nutrients in the water). Also, the activated oxygen saturated water will oxidize the nutrients in making it easier for the roots to assimilate the nutrients.

It has been observed the shelf life of the product is extended.

The activated oxygen system requires no chemicals or additives.

The activated oxygen system requires minimal maintenance.

The activated oxygen system requires minimal operating cost.

The activated oxygen system does not require highly skilled workers.

The activated oxygen system does not require constant monitoring.

Also, since there is no need for chlorine, the EPA/OSHA requirements for a safe work place environment are easily met.

What is claimed is:

1. A process for treatment of seeds, comprising the steps of:
A. Putting the seeds into a holding, soaking, or chilling tank
B. Sparging activated oxygen into the water for a specific time to attain maximum bacteria reduction (dependent on size of tank and quantity of water).

2. The process according to claim one wherein seeds (such as, but not limited to, alfalfa, beans, sunflower, radish, carrot, watermelon, tomato, pepper, lettuce, etc.) are treated with activated oxygen to attain maximum bacteria reduction.

3. The process according to claim one wherein seeds (such as, but not limited to, alfalfa, beans, sunflower, radish, carrot, watermelon, tomato, pepper, lettuce, etc.) are treated with activated oxygen to attain maximum bacteria reduction;
The process according to claim one where in the water used during germination and sprouting/growing duration is saturated with activated oxygen and sprayed on the seed.
Process according to claim one wherein the water used during wash down rinse is saturated with activated oxygen (this reduces the possibility of contaminated effluent) during process.
